(19) United States
(12) Patent Application Publication
(10) Pub. No.: US 2024/0062103 A1
(43) Pub. Date: Feb. 22, 2024

(54) MACHINE LEARNING SYSTEM, EDGE DEVICE, AND INFORMATION PROCESSING DEVICE

(71) Applicant: KABUSHIKI KAISHA TOSHIBA, Tokyo (JP)

(72) Inventor: Manabu NISHIYAMA, Setagaya Tokyo (JP)

(73) Assignee: KABUSHIKI KAISHA TOSHIBA, Tokyo (JP)

(21) Appl. No.: 18/173,873

(22) Filed: Feb. 24, 2023

(30) Foreign Application Priority Data
Aug. 19, 2022 (JP) 2022-131190

(51) Int. Cl. G06N 20/00

(52) U.S. Cl. CPC G06N 20/00

(57) ABSTRACT

A machine learning system includes first and second information processing devices. The first-information-processing device includes a first-evaluation unit, a first-selection unit, and a candidate-data-transmission unit. The first-evaluation unit calculates a first evaluation value for each of candidate data pieces based on a first evaluation standard. The first-selection unit selects whether each input data is included in the candidate data pieces based on the first evaluation value. The candidate-data-transmission unit transmits the candidate data. The second-information-processing device includes a candidate-data-reception unit, a second-evaluation unit, and a second-selection unit. The candidate-data-reception unit receives the candidate data. The second-evaluation unit calculates a second evaluation value for each candidate data based on a second evaluation standard different from the first evaluation standard. The second-selection unit selects whether each candidate data is included in learning data pieces based on the second evaluation value.

### CROSS-REFERENCE TO RELATED APPLICATIONS

This application is based upon and claims the benefit of priority from Japanese Patent Application No. 2022-131190, filed on Aug. 19, 2022; the entire contents of which are incorporated herein by reference.

### FIELD

Embodiments described herein relate generally to a machine learning system, an edge device, and an information processing device.

### BACKGROUND

There is known a machine learning system in which a machine learning model that has performed learning on a cloud is deployed to an edge device on which a surveillance camera and the like are mounted, for example, and the edge device executes inference processing based on the machine learning model. Such a system does not necessarily transmit input data such as an image taken by the surveillance camera to the cloud, so that a communication burden is reduced.

Regarding such a machine learning system, there is known a machine learning operation for which input data collected by the edge device is transmitted to the cloud, and the machine learning model performs relearning on the cloud. By applying such a machine learning operation to the machine learning system, the machine learning system can use a machine learning model that is more appropriate for the applied environment.

The machine learning system has been required to select a piece of input data that is effective for relearning from among a large amount of input data to cause the machine learning model to perform relearning efficiently.

However, resource for information processing of the edge device is limited. As such, it has been difficult for the edge device to execute selection processing requiring a large arithmetic amount. The cloud has a high information processing capacity, and thus the cloud can execute selection processing requiring a large arithmetic amount. However, in a case of transmitting a large amount of input data collected by the edge device to the cloud, a communication burden on the machine learning system has been greatly increased.

### BRIEF DESCRIPTION OF THE DRAWINGS

FIG. 1 is a diagram illustrating a configuration of a machine learning system according to an embodiment;

FIG. 2 is a functional configuration diagram of an edge device and a cloud device;

FIG. 3 is a flowchart of the edge device and the cloud device;

FIG. 4 is a diagram for explaining an example of a calculation method for a first evaluation value;

FIG. 5 is a diagram for explaining a first example of a calculation method for a second evaluation value;

FIG. 6 is a diagram for explaining a second example of the calculation method for the second evaluation value;

FIG. 7 is a diagram for explaining a third example of the calculation method for the second evaluation value;

FIG. 8 is a diagram for explaining a fourth example of the calculation method for the second evaluation value;

FIG. 9 is a diagram for explaining a fifth example of the calculation method for the second evaluation value;

FIG. 10 is a diagram for explaining a sixth example of the calculation method for the second evaluation value;

FIG. 11 is a functional configuration diagram of an edge device and a cloud device according to a modification; and

FIG. 12 is a diagram illustrating an example of a hardware configuration of an information processing device.

### DETAILED DESCRIPTION

A machine learning system according to an embodiment is configured to select a plurality of pieces of learning data for causing a first machine learning model to perform learning from among a plurality of pieces of input data. The machine learning system includes a first information processing device and a second information processing device connected to the first information processing device via a network.

The first information processing device includes a first evaluation unit, a first selection unit, and a candidate data transmission unit. The first evaluation unit is configured to calculate a first evaluation value representing effectiveness of each of the pieces of input data when being used for learning of the first machine learning model based on a first evaluation standard determined in advance. The first selection unit is configured to select whether each of the pieces of input data is included in a plurality of pieces of candidate data by comparing the first evaluation value of each of the pieces of input data with a value determined in advance. The candidate data transmission unit is configured to transmit each of the pieces of candidate data to the second information processing device via the network.

The second information processing device includes a candidate data reception unit, a second evaluation unit, and a second selection unit. The candidate data reception unit is configured to receive each of the pieces of candidate data from the first information processing device via the network. The second evaluation unit is configured to calculate a second evaluation value indicating effectiveness of each of the pieces of candidate data when being used for learning of the first machine learning model based on a second evaluation standard determined in advance, the second evaluation standard being different from the first evaluation standard. The second selection unit is configured to select whether each of the pieces of candidate data is included in the pieces of learning data by comparing the second evaluation value of each of the pieces of candidate data with a value determined in advance.

A problem to be solved by the embodiments herein is to provide a machine learning system, an edge device, and an information processing device that can efficiently select a piece of input data effective for learning from among a plurality of pieces of input data.

The following describes an embodiment of the present invention with reference to the drawings.

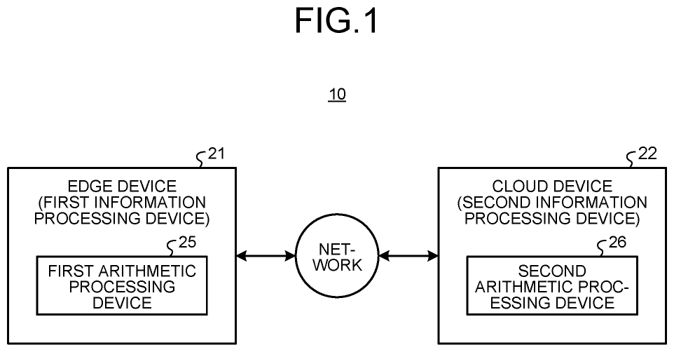

FIG. 1 is a diagram illustrating a configuration of a machine learning system 10 according to the embodiment.

The machine learning system 10 acquires a plurality of pieces of time-series input data, and executes inference processing on each of the acquired pieces of input data using a first machine learning model set in advance. Additionally, the machine learning system 10 selects a plurality of pieces of learning data for causing the first machine learning model to perform learning from among the acquired pieces of input data. The machine learning system 10 then causes the first machine learning model to perform relearning by using the selected and obtained pieces of learning data.

The machine learning system 10 includes an edge device 21 and a cloud device 22.

The edge device 21 is an example of a first information processing device. The edge device 21 collects the pieces of input data on a time-series basis from surrounding environment, and executes information processing on each of the collected pieces of input data. The edge device 21 transmits a result of the information processing for each of the pieces of input data to the cloud device 22 via a network.

The cloud device 22 is an example of a second information processing device. The cloud device 22 is connected to the edge device 21 via the network. The cloud device 22 acquires the result of information processing on each of the pieces of input data from the edge device 21 via the network. The cloud device 22 outputs the result of information processing on each of the pieces of input data to a user and the like, or further executes information processing on the result of the information processing.

The edge device 21 includes a first arithmetic processing device 25 as hardware. The first arithmetic processing device 25 is a processing circuit constituted of one or a plurality of central processing units (CPUs) and the like, for example. The first arithmetic processing device 25 executes information processing performed by the edge device 21.

The cloud device 22 is an information processing device such as a server device, for example. The cloud device 22 may be a server device in which a plurality of information processing devices operate in cooperation with each other, for example. The cloud device 22 includes a second arithmetic processing device 26 as hardware. The second arithmetic processing device 26 is a processing circuit constituted of one or a plurality of CPUs and the like, for example. The second arithmetic processing device 26 executes information processing performed by the cloud device 22.

The second arithmetic processing device 26 executes information processing with higher arithmetic accuracy than that of the first arithmetic processing device 25. For example, in a case in which the first arithmetic processing device 25 executes floating-point arithmetic processing with 32-bit accuracy, the second arithmetic processing device 26 executes floating-point arithmetic processing with 64-bit accuracy. Due to this, in a case of executing the same arithmetic processing as that of the first arithmetic processing device 25, the second arithmetic processing device 26 can obtain an arithmetic result different from that of the first arithmetic processing device 25.

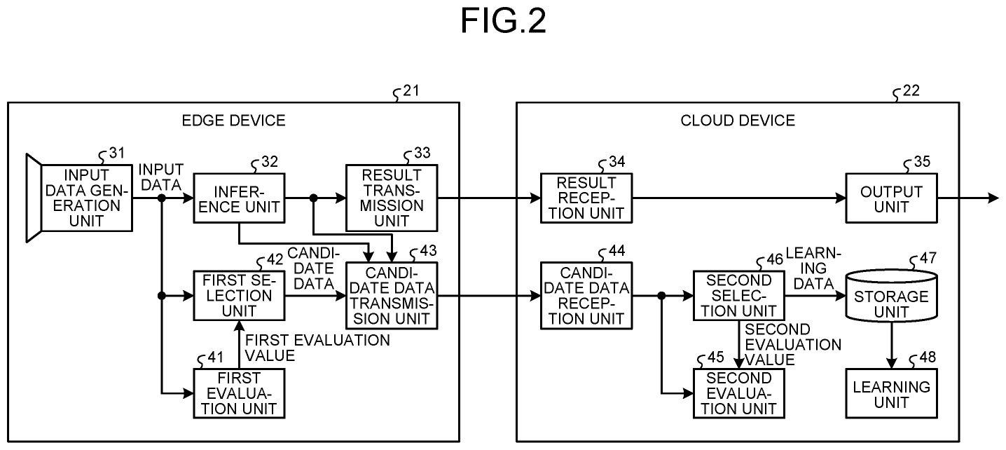

FIG. 2 is a block diagram illustrating a functional configuration of the edge device 21 and the cloud device 22.

The edge device 21 includes an input data generation unit 31, an inference unit 32, and a result transmission unit 33. The cloud device 22 includes a result reception unit 34 and an output unit 35.

The input data generation unit 31 collects observation results obtained by observing the surroundings of the edge device 21. The input data generation unit 31 generates a plurality of pieces of input data arranged on a time-series basis based on the collected observation results. The input data generation unit 31 may be an imaging device, for example. In this case, the input data generation unit 31 images the surroundings at each predetermined time, and generates image data representing the imaged surroundings as the input data. Alternatively, the input data generation unit 31 may be a microphone device. In this case, the input data generation unit 31 collects surrounding voices, and generates, as the input data, voice data in units of a time length determined in advance. Alternatively, the input data generation unit 31 may be one or a plurality of sensor devices. In this case, the input data generation unit 31 senses a temperature, humidity, or the like of an object at each predetermined time, and generates sensor data as the input data.

The inference unit 32 successively acquires the respective pieces of time-series input data. The inference unit 32 performs inference processing on each of the pieces of time-series input data based on the first machine learning model, and outputs an inference result obtained by performing the inference processing. For example, the inference unit 32 acquires each of the pieces of input data on a time-series basis, performs inference processing each time of acquiring each of the pieces of input data, and outputs the inference result obtained by performing the inference processing.

The first machine learning model is a neural network that has learned parameters in advance, for example. In a case in which the first machine learning model is the neural network, the inference unit 32 gives the acquired input data to the neural network, and acquires an inference result output from the neural network.

The result transmission unit 33 transmits the inference result output from the inference unit 32 to the cloud device 22 via the network. The result transmission unit 33 may transmit the inference result to the cloud device 22 only in a case in which an inference result determined in advance is output from the inference unit 32. For example, the result transmission unit 33 may transmit the inference result to the cloud device 22 only in a case in which a person included in the image data is identified as a person determined in advance.

The result reception unit 34 receives the inference result from the edge device 21 via the network.

In a case in which the result reception unit 34 receives the inference result, the output unit 35 causes the received inference result to be output from a terminal device held by the user, or to be displayed on a display device, for example. The output unit 35 may further transmit the received inference result to another information processing device.

The machine learning system 10 as described above can generate the pieces of input data on a time-series basis, and execute inference processing on each of the generated pieces of input data by using the first machine learning model set in advance.

The edge device 21 further includes a first evaluation unit 41, a first selection unit 42, and a candidate data transmission unit 43. The cloud device 22 further includes a candidate data reception unit 44, a second evaluation unit 45, a second selection unit 46, a storage unit 47, and a learning unit 48.

The first evaluation unit 41 acquires each of the pieces of input data generated by the input data generation unit 31. The first evaluation unit 41 calculates a first evaluation value representing effectiveness of each of the pieces of input data when being used for learning of the first machine learning model based on a first evaluation standard determined in advance. For example, the first evaluation unit 41 acquires the respective pieces of input data in order of generation on a time-series basis, and calculates the first evaluation value each time of acquiring each of the pieces of input data.

The first evaluation value may be a value representing, by a real number, the effectiveness when the data is used for learning of the first machine learning model, for example. The first evaluation value may be a binary value indicating that the data is effective or ineffective.

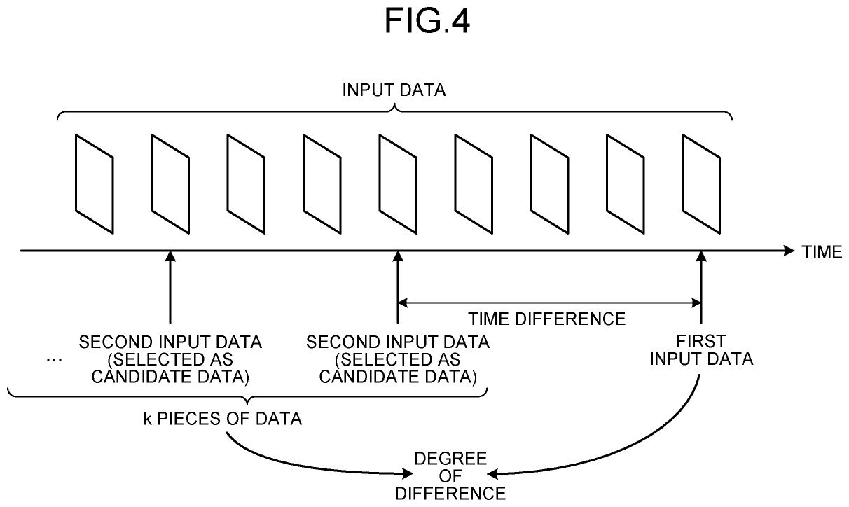

In the present embodiment, the first evaluation unit 41 calculates the first evaluation value for optional first input data among the pieces of input data based on a relation between the first input data and data different from the first input data. An example of a calculation method for the first evaluation value performed by the first evaluation unit 41 will be described later in detail with reference to FIG. 4.

The first selection unit 42 acquires the pieces of input data generated by the input data generation unit 31. The first selection unit 42 also acquires first evaluation values for the acquired pieces of input data from the first evaluation unit 41.

By comparing the first evaluation value of each of the pieces of input data with a value determined in advance, the first selection unit 42 selects whether each of the pieces of input data is to be included in a plurality of pieces of candidate data. The respective pieces of candidate data are data as candidates for a plurality of pieces of learning data for causing the first machine learning model to perform learning.

For example, in a case in which the first evaluation value is represented by a real number, the first selection unit 42 selects, as the candidate data, the input data the first evaluation value of which is equal to or larger than a value determined in advance or equal to or smaller than a value determined in advance from among the pieces of input data. For example, in a case in which the first evaluation value is represented by a binary value, the first selection unit 42 selects, as the candidate data, the input data having the first evaluation value indicating that the data is effective from among the pieces of input data.

For example, the first selection unit 42 may acquire the respective pieces of input data on a time-series basis. In this case, each time of acquiring each of the pieces of input data, the first selection unit 42 determines whether to select the acquired input data as the candidate data.

The candidate data transmission unit 43 transmits the respective pieces of candidate data selected by the first selection unit 42 to the cloud device 22 via the network. For example, the candidate data transmission unit 43 acquires the respective pieces of candidate data from the first selection unit 42 on a time-series basis. Each time of acquiring each of the pieces of candidate data, the candidate data transmission unit 43 transmits the acquired candidate data to the cloud device 22 via the network.

The candidate data reception unit 44 receives the respective pieces of candidate data from the edge device 21 via the network. For example, the candidate data reception unit 44 receives the respective pieces of candidate data from the edge device 21 on a time-series basis.

The second evaluation unit 45 acquires each of the pieces of candidate data received by the candidate data reception unit 44. The second evaluation unit 45 calculates a second evaluation value representing effectiveness of each of the pieces of candidate data when being used for learning of the first machine learning model based on a second evaluation standard determined in advance, where the second evaluation standard is different from the first evaluation standard. For example, the second evaluation unit 45 acquires the respective pieces of candidate data in order of reception on a time-series basis, and calculates the second evaluation value each time of acquiring each of the pieces of candidate data.

The second evaluation value may be a value representing, by a real number, the effectiveness when the data is used for learning of the first machine learning model, for example. The second evaluation value may be a binary value indicating that the data is effective or ineffective.

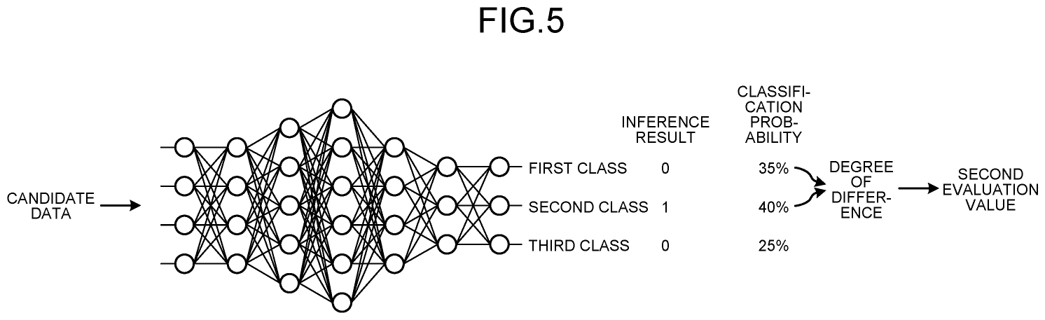

In the present embodiment, the second evaluation unit 45 calculates the second evaluation value for optional first candidate data among the pieces of candidate data by analyzing an inference result or an intermediate result obtained by inputting the first candidate data to any of machine learning models. More specifically, the second evaluation unit 45 calculates the second evaluation value that becomes larger or smaller as unreliability of the inference result obtained by inputting the first candidate data to the first machine learning model is higher based on the inference result or the intermediate result obtained by inputting the first candidate data to any of the machine learning models. An example of a calculation method for the second evaluation value performed by the second evaluation unit 45 will be described later in detail with reference to FIG. 5 to FIG. 10.

In a case in which the second evaluation unit 45 calculates the second evaluation value using at least one of the inference result and the intermediate result obtained by inputting the first candidate data to the first machine learning model, which is calculated by the inference unit 32 of the edge device 21, the candidate data transmission unit 43 of the edge device 21 transmits at least one of the inference result and the intermediate result together with the first candidate data via the network. In this case, the candidate data reception unit 44 receives at least one of the inference result and the intermediate result together with the first candidate data from the edge device 21. The second evaluation unit 45 then calculates the second evaluation value using the inference result and the intermediate result received by the candidate data reception unit 44.

The second selection unit 46 acquires the pieces of candidate data received by the candidate data reception unit 44. The second selection unit 46 also acquires second evaluation values for the received pieces of candidate data from the second evaluation unit 45.

By comparing the second evaluation value of each of the pieces of candidate data received by the candidate data reception unit 44 with a value determined in advance, the second selection unit 46 selects whether each of the pieces of candidate data is to be included in the pieces of learning data. Each of the pieces of learning data is data to be a teacher for causing the first machine learning model to perform relearning.

For example, in a case in which the second evaluation value is represented by a real number, the second selection unit 46 selects, as the learning data, the candidate data the second evaluation value of which is equal to or larger than a value determined in advance or equal to or smaller than a value determined in advance from among the pieces of candidate data. For example, in a case in which the second evaluation value is represented by a binary value, the second selection unit 46 selects, as the learning data, the candidate data having the second evaluation value indicating that the data is effective from among the pieces of candidate data.

For example, the second selection unit 46 may acquire the respective pieces of candidate data in order of reception on a time-series basis. In this case, each time of acquiring each of the pieces of candidate data, the second selection unit 46 determines whether to select the acquired candidate data as the learning data.

The storage unit 47 stores the pieces of learning data selected by the second selection unit 46.

At a timing determined in advance, or in a case of receiving a predetermined instruction, for example, the learning unit 48 trains the first machine learning model using the pieces of learning data stored in the storage unit 47. After training the first machine learning model, the learning unit 48 transmits parameters set in the first machine learning model to the edge device 21 to update the parameters of the first machine learning model used for inference processing by the edge device 21.

The machine learning system 10 as described above can select the pieces of learning data for causing the first machine learning model to perform learning from among the acquired pieces of input data. The machine learning system 10 then can cause the first machine learning model to perform relearning by using the selected and obtained pieces of learning data.

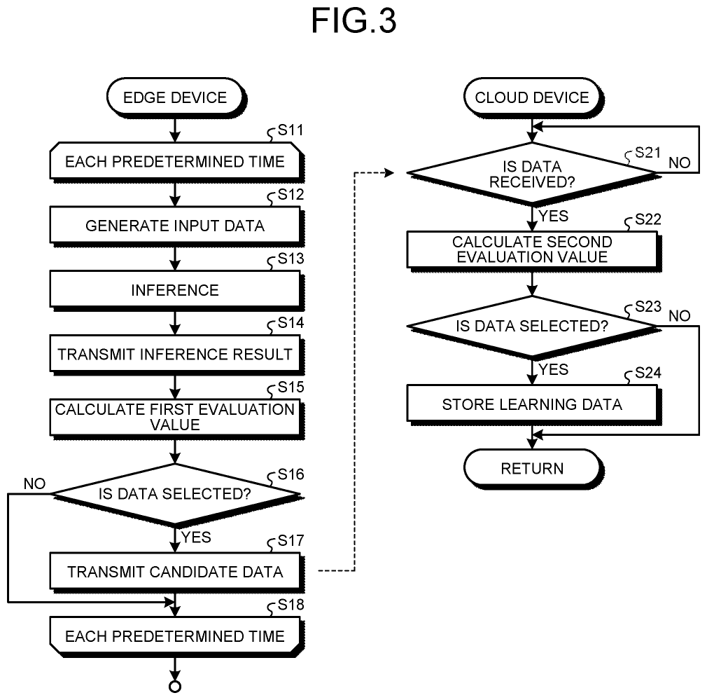

FIG. 3 is a flowchart illustrating a processing procedure performed by the edge device 21 and the cloud device 22. The machine learning system 10 executes processing with a flow illustrated in FIG. 3.

The edge device 21 executes processing at S12 to S17 at each predetermined time (loop processing between S11 and S18).

In a loop, first, at S12, the edge device 21 collects observation results obtained by observing the surroundings of the edge device 21, and generates the input data based on the collected observation results. For example, the edge device 21 images the surroundings, and generates image data representing the imaged surroundings as the input data.

Subsequently, at S13, the edge device 21 performs inference processing on the input data based on the first machine learning model. For example, the edge device 21 classifies the acquired input data into any of a plurality of classes determined in advance using the first machine learning model.

Subsequently, at S14, the edge device 21 transmits the inference result to the cloud device 22 via the network. The edge device 21 may transmit the inference result to the cloud device 22 only in a case in which an inference result determined in advance is output. For example, the edge device 21 may transmit the inference result to the cloud device 22 only in a case in which a person included in the image data is identified as a person determined in advance.

Subsequently, at S15, the edge device 21 calculates the first evaluation value for the acquired input data based on the first evaluation standard.

Subsequently, at S16, the edge device 21 determines whether to select the generated input data as the candidate data as a candidate to be employed as the learning data based on the first evaluation value.

In a case of selecting the generated input data as the candidate data (Yes at S16), the edge device 21 advances the process to S17.

At S17, the edge device 21 transmits the generated input data to the cloud device 22 as the candidate data.

In a case of not selecting the generated input data as the candidate data (No at S16) or in a case of completing transmission processing at S17, the edge device 21 ends the processing in the loop between S11 and S18, and repeats the processing from S12 after a predetermined time has elapsed.

The edge device 21 may execute the processing from S13 to S14 and the processing from S15 to S17 in parallel.

On the other hand, the cloud device 22 executes the processing from S21.

At S21, the cloud device 22 determines whether the candidate data is received from the edge device 21. In a case of not receiving the candidate data from the edge device 21 (No at S21), the cloud device 22 stands by for the process at S21. In a case of receiving the candidate data from the edge device 21 (Yes at S21), the cloud device 22 advances the process to S22.

At S22, the cloud device 22 calculates the second evaluation value for the received candidate data based on the second evaluation standard.

Subsequently, at S23, the cloud device 22 determines whether to select the received candidate data as the learning data based on the second evaluation value.

In a case of selecting the received candidate data as the learning data (Yes at S23), the cloud device 22 advances the process to S24.

At S24, the cloud device 22 stores the received candidate data in the storage unit 47 as the learning data.

In a case of not selecting the received candidate data as the learning data (No at S23), or in a case of ending storage processing at S24, the cloud device 22 returns the process to S21, and repeats the process from S21.

At a timing determined in advance, or in a case of receiving a predetermined instruction, the cloud device 22 trains the first machine learning model using the pieces of learning data stored in the storage unit 47. After training the first machine learning model, the cloud device 22 transmits the parameters set in the first machine learning model to the edge device 21 to update the parameters of the first machine learning model used for inference processing by the edge device 21.

FIG. 4 is a diagram for explaining an example of the calculation method for the first evaluation value.

In the present embodiment, the first evaluation unit 41 calculates the first evaluation value for each of the pieces of input data based on a correlation with the other pieces of input data. More specifically, the first evaluation unit 41 calculates the first evaluation value for the first input data among the pieces of input data based on a correlation between the first input data and one or more pieces of second input data different from the first input data among the pieces of input data. The first selection unit 42 then determines whether to select the first input data as one of the pieces of candidate data as a candidate to be employed as the learning data based on the first evaluation value calculated as described above.

The pieces of time-series input data have the property that two or more pieces of data that are temporally close to each other have a high correlation and are similar to each other with high possibility. Thus, by calculating the first evaluation value based on a correlation between the first input data and one or more pieces of the second input data different from the first input data, the edge device 21 can select the pieces of candidate data that are greatly different from each other from among the pieces of input data. By performing learning using the pieces of data that are greatly different from each other, that is, that are varied, it can be expected that the machine learning model performs inference on extensive input data with high accuracy. Accordingly, by selecting such input data as one of the pieces of candidate data to be transmitted to the cloud device 22 as a candidate for the learning data, the edge device 21 can cause the first machine learning model to perform relearning with high accuracy.

Additionally, a load of the processing of calculating the correlation between the pieces of data is lighter as compared with that of processing of analyzing the inference result or the intermediate result of the machine learning model, for example. Thus, by calculating the first evaluation value based on the correlation between the first input data and one or more pieces of the second input data, the edge device 21 can determine whether to select the first input data as the candidate data with relatively simple processing, and the processing can be easily implemented even if arithmetic resource of the edge device 21 is limited.

For example, the first evaluation unit 41 calculates, as the first evaluation value, a value according to a time difference between acquisition time of the first input data and acquisition time of the second input data that is selected as one of the pieces of candidate data immediately before the first input data from among one or more pieces of the second input data. For example, by comparing the first evaluation value with a standard value determined in advance, the first selection unit 42 selects the first input data as one of the pieces of candidate data. For example, the first evaluation unit 41 generates the first evaluation value that becomes a larger value as the time difference is larger. In this case, the first selection unit 42 selects, as the candidate data, the first input data having the first evaluation value larger than the standard value.

A difference between first input data and the second input data included in the pieces of time-series input data may be larger with high possibility as a difference in the acquisition time is larger. Accordingly, by increasing the first evaluation value of the input data for which the difference in the acquisition time from that of the immediately preceding candidate data is large, the first evaluation unit 41 enables selecting, as the candidate data, the input data for causing the machine learning model to perform learning with high accuracy.

For example, the first evaluation unit 41 may calculate, as the first evaluation value, a value according to a degree of difference representing a difference between the first input data and k (k is an integral number equal to or larger than 1) pieces of the candidate data immediately before the first input data among the pieces of candidate data. The first selection unit 42 then compares the first evaluation value with the standard value determined in advance, and selects the first input data as one of the pieces of candidate data. For example, the first evaluation unit 41 generates the first evaluation value that becomes a larger value as the difference is larger. In this case, the first selection unit 42 selects, as the candidate data, the first input data having the first evaluation value larger than the standard value. The degree of difference between the pieces of data can be calculated by using evaluation indexes used in typical image processing such as a Sum of Absolute Difference (SAD, a sum total of an absolute value of a difference), a Sum of Squared Difference (SSD, a sum total of a square of a difference), and a normalized cross-correlation value. A degree of difference between the other pieces of data such as a voice or text can also be calculated by using the same evaluation indexes.

For example, the first evaluation unit 41 may calculate the degree of difference based on an average value, a maximum value, or the like of a difference between the first input data and each of the k pieces of candidate data. The first evaluation unit 41 may also calculate the degree of difference based on an average value, a maximum value, or the like of a difference between a characteristic amount obtained by inputting the first input data to a predetermined function or a predetermined model and a characteristic amount obtained by inputting each of the k pieces of candidate data to the predetermined function or the predetermined model. Alternatively, for example, the first evaluation unit 41 may calculate a correlation value by inputting the first input data and each of the k pieces of candidate data to a function or a model for calculating the correlation value representing strength of a correlation between the two pieces of data, and calculate the degree of difference based on the correlation value. By calculating the first evaluation value as described above, the first evaluation unit 41 can cause the candidate data for causing the machine learning model to perform learning with high accuracy to be selected.

A comparison target of the degree of difference of the first evaluation unit 41 may be selected from the learning data that has been used for training the first machine learning model. For example, the degree of difference from the first input data can be calculated by obtaining k representative values from the learning data of the first machine learning model, or the degree of difference can be calculated from a difference in the characteristic amount obtained by inputting the k representative values of the learning data and the first input data. Alternatively, a new machine learning model that outputs a degree of difference from the learning data of the first machine learning model may be trained separately from the first machine learning model, and the candidate data can be selected based on a degree of difference obtained by inputting the first input data to this machine learning model.

The first evaluation value may be a value representing a binary value of “effectiveness” or “ineffectiveness”. In this case, the first evaluation unit 41 calculates the first evaluation value based on a random number such that “effectiveness” or “ineffectiveness” occurs with a probability set in advance. Furthermore, the first selection unit 42 selects the first input data having the first evaluation value indicating “effectiveness” as one of the pieces of candidate data. For example, in a case in which the probability of “effectiveness” is set to be 0.1%, the first evaluation unit 41 causes the first evaluation value of the first input data to be a value indicating “effectiveness” with a probability of 0.1%, and to be a value indicating “ineffectiveness” with a probability of 99.9%.

Alternatively, the first evaluation unit 41 may calculate the first evaluation value based on a combination of any two or more of the time difference described above, the degree of difference described above, and the probability described above.

For example, in a case in which the first evaluation value is a value representing a binary value of “effectiveness” or “ineffectiveness”, the first evaluation unit 41 may calculate the first evaluation value while increasing the probability of “effectiveness” as a time difference between the acquisition time of the first input data and the acquisition time of the second input data is larger, the second input data being selected as one of the pieces of candidate data immediately before the first input data from among one or more pieces of the second input data.

Alternatively, for example, the first evaluation unit 41 may cause the first evaluation value to be a value indicating “effectiveness” in a case in which the degree of difference between the first input data and the k pieces of candidate data immediately before the first input data is equal to or larger than a threshold set in advance, and the value indicating “effectiveness” is determined based on a random number with a predetermined probability or a probability corresponding to the time difference.

For example, the first evaluation unit 41 may employ any of calculation methods using the time difference described above, the degree of difference described above, the probability described above, or a combination of two or more of them in accordance with a load of data processing performed by the edge device 21. For example, the first evaluation unit 41 may employ a calculation method using a combination of two or more of them in a case in which the load of data processing is smaller than a predetermined value, or may employ a calculation method using any one of the time difference described above, the degree of difference described above, and the probability described above, for example, in a case in which the load of data processing is larger than the predetermined value. Accordingly, the first evaluation unit 41 makes selection of the candidate data for causing the machine learning model to perform learning with high accuracy within a range of arithmetic capacity of the edge device 21.

As described above, by calculating the first evaluation value and transmitting the candidate data as the candidate for the learning data from among the pieces of input data, the edge device 21 can reduce the possibility of transmitting, to the cloud device 22, the pieces of candidate data similar to each other. Accordingly, the edge device 21 can select the pieces of candidate data effective for relearning from among the pieces of input data through relatively simple processing, and can reduce a transmission amount of data to the cloud device 22.

FIG. 5 is a diagram for explaining a first example of the calculation method for the second evaluation value.

In the present embodiment, the second evaluation unit 45 calculates the second evaluation value for the first candidate data among the pieces of candidate data transmitted from the edge device 21 based on the inference result or the intermediate result obtained by inputting the first candidate data to the machine learning model. For example, the second evaluation unit 45 calculates, as the second evaluation value, a value according to the possibility that the inference result is unreliable in a case of inputting the first candidate data to the first machine learning model. The second selection unit 46 then determines whether to select the first candidate data as one of the pieces of learning data based on the second evaluation value calculated as described above.

The inference result of the machine learning model may vary in a case in which a value in the input data minutely varies. The inference result of the machine learning model may also vary in a case in which a parameter such as a weight in a neural network or a connection relation minutely varies. Input data having a high classification probability of belonging to two or more classes at the same time may be input to the machine learning model that classifies data into any of a plurality of classes. Input data the inference result of which varies when arithmetic accuracy of hardware to be executed is different may be input to the machine learning model.

In a case in which such pieces of input data are input, inference results of the machine learning model are varied or changed, and unreliability is increased. Thus, by performing relearning using the input data with which unreliability of the inference result becomes higher, the machine learning model can be expected to stably perform inference processing with high accuracy even when extensive data is input. Thus, the cloud device 22 selects such input data as one of the pieces of learning data to be used for relearning performed by the first machine learning model. Due to this, the cloud device 22 can cause the first machine learning model to perform relearning with high accuracy.

Furthermore, a load of the processing of calculating the second evaluation value by analyzing the inference result or the intermediate result obtained by inputting the data to the machine learning model is heavier as compared with that of the processing of calculating the correlation between the pieces of data. However, the cloud device 22 has a larger number of arithmetic resources as compared with the edge device 21. Due to this, the cloud device 22 can determine whether to select the first candidate data as one of the pieces of learning data relatively easily. The cloud device 22 also calculates the second evaluation value for each of the pieces of candidate data in part of the pieces of input data. Thus, the cloud device 22 can reduce throughput for calculating the second evaluation value.

In the first example, the first machine learning model classifies the input data into any of a plurality of classes. In this case, the second evaluation unit 45 acquires a classification probability of belonging to each of the classes obtained by inputting the first candidate data to the first machine learning model. Furthermore, the second evaluation unit 45 calculates, as the second evaluation value, a value according to a degree of difference representing a difference between a classification probability of a class into which the first candidate data is classified as belonging and a classification probability of each of one or a plurality of classes into which the first candidate data is classified as not belonging among the classes. The second selection unit 46 then compares the second evaluation value with a standard value determined in advance, and selects the first candidate data as one of the pieces of learning data.

For example, the second evaluation unit 45 calculates the second evaluation value that becomes a large value in a case in which the degree of difference is small, that is, the classification probability of belonging to two or more classes is high. In this case, the second selection unit 46 selects the first candidate data as one of the pieces of learning data in a case in which the second evaluation value is larger than the standard value.

For example, in the example of FIG. 5, in a case in which the first candidate data is input to the first machine learning model, the classification probability for a first class is 35%, the classification probability for a second class is 40%, and the classification probability for a third class is 25%. In such a case, the second evaluation unit 45 calculates, as the degree of difference, a difference (5%) between the classification probability (40%) for the second class and the classification probability (35%) for the first class, and calculates the second evaluation value that becomes a larger value as the calculated degree of difference is smaller.

The input data for which a difference between the classification probability for the class obtained as the inference result and the classification probability for the other class is small has a high classification probability of belonging to two or more classes, and the inference result obtained by the first machine learning model may become unreliable with high possibility. Thus, by causing such candidate data to be selected as one of the pieces of learning data, the second evaluation unit 45 according to the first example can cause the first machine learning model to perform relearning with high accuracy.

In a case in which the machine learning model is a neural network, such a classification probability for each class is output from a final layer or a layer preceding the final layer. Thus, in a case in which the second evaluation unit 45 calculates the second evaluation value as described above, the candidate data transmission unit 43 of the edge device 21 may transmit the candidate data to the cloud device 22, and also transmit, to the cloud device 22, the inference result of the inference unit 32 and the intermediate result obtained from a layer that outputs the classification probability. The second evaluation unit 45 then may calculate the second evaluation value based on the inference result and the intermediate result received from the edge device 21. Due to this, the second evaluation unit 45 can reduce the arithmetic amount for calculating the second evaluation value.

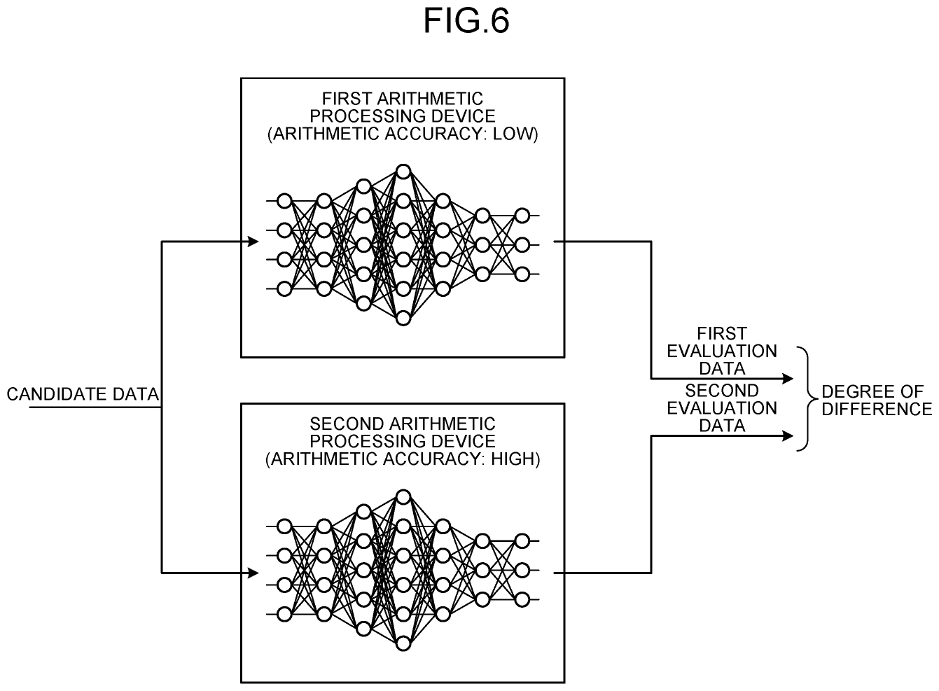

FIG. 6 is a diagram for explaining a second example of the calculation method for the second evaluation value.

The second evaluation unit 45 according to the second example calculates, as the second evaluation value, a value according to a degree of difference representing a difference between first evaluation data calculated by the first arithmetic processing device 25 as hardware having first arithmetic accuracy and second evaluation data calculated by the second arithmetic processing device 26 as hardware having second arithmetic accuracy higher than the first arithmetic accuracy.

More specifically, the first evaluation data according to the second example includes at least one of output data of the first machine learning model and intermediate data output from a predetermined position in the first machine learning model calculated by the first arithmetic processing device 25 provided in the edge device 21 and obtained by inputting the first candidate data to the first machine learning model. The second evaluation data according to the second example includes data corresponding to the first evaluation data, which is any of the output data of the first machine learning model and the intermediate data output from the predetermined position in the first machine learning model calculated by the second arithmetic processing device 26 provided in the cloud device 22 and obtained by inputting the first candidate data to the first machine learning model.

The second selection unit 46 according to the second example then compares the second evaluation value with the standard value determined in advance, and selects the first candidate data as one of the pieces of learning data. For example, the second evaluation unit 45 calculates the second evaluation value that becomes a larger value as the degree of difference is larger. In this case, the second selection unit 46 selects the first candidate data as one of the pieces of learning data in a case in which the second evaluation value is larger than the standard value.

In a case in which estimation results calculated by two arithmetic processing devices having different arithmetic accuracy are different from each other as described above, it is assumed that the inference result obtained by the first machine learning model using the input data becomes unreliable with high possibility. Thus, by causing such input data to be selected as one of the pieces of learning data, the second evaluation unit 45 according to the second example can cause the first machine learning model to perform relearning with high accuracy.

The candidate data transmission unit 43 of the edge device 21 according to the second example acquires the first evaluation data from the inference unit 32, and transmits the first evaluation data to the cloud device 22 via the network. The second evaluation unit 45 acquires the first evaluation data received from the edge device 21. The second evaluation unit 45 calculates the second evaluation data by the second arithmetic processing device 26 provided in the cloud device 22. The second evaluation unit 45 then calculates the second evaluation value based on the first evaluation data received from the edge device 21 and the second evaluation data calculated by the second arithmetic processing device 26 provided in the cloud device 22. Due to this, the second evaluation unit 45 is not required to execute arithmetic processing for calculating the first evaluation data, so that the arithmetic amount for calculating the second evaluation value can be reduced.

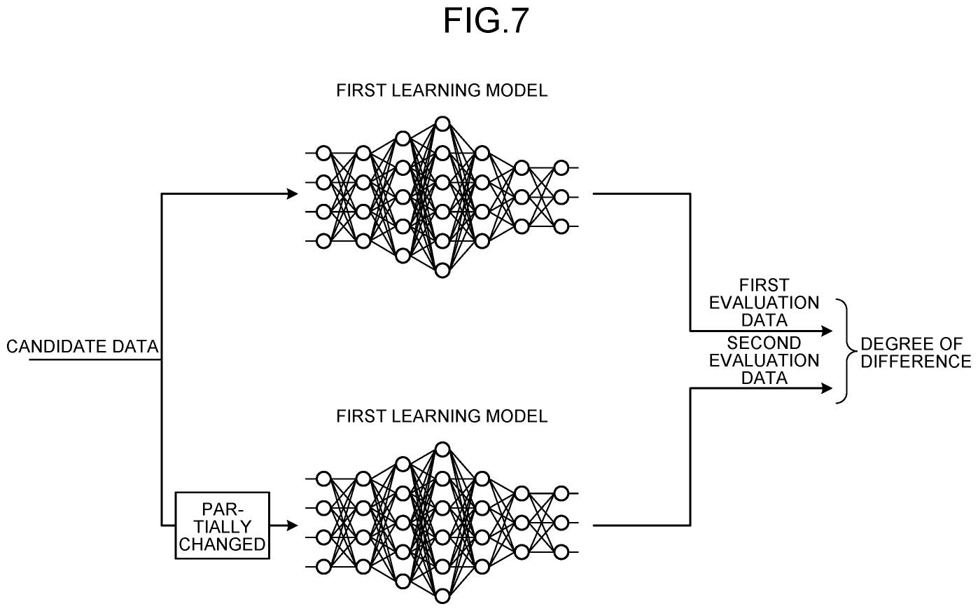

FIG. 7 is a diagram for explaining a third example of the calculation method for the second evaluation value performed by the second evaluation unit 45.

The second evaluation unit 45 according to the third example calculates, as the second evaluation value, a value according to a degree of difference representing a difference between the first evaluation data obtained by inputting the first candidate data to the first machine learning model and the second evaluation data obtained by inputting data that is obtained by partially changing the first candidate data to the first machine learning model.

More specifically, the first evaluation data according to the third example includes at least one of the output data of the first machine learning model and the intermediate data output from the predetermined position in the first machine learning model obtained by inputting the first candidate data to the first machine learning model. The second evaluation data according to the third example includes data corresponding to the first evaluation data, which is any of the output data of the first machine learning model and the intermediate data output from the predetermined position in the first machine learning model obtained by inputting the data obtained by changing part of values of the first candidate data to the first machine learning model.

Similarly to the second example, the second selection unit 46 according to the third example compares the second evaluation value with the standard value determined in advance, and selects the first candidate data as one of the pieces of learning data.

In a case in which the estimation result is different from that of the input data that has been minutely changed, it is assumed that the inference result obtained by the first machine learning model using the input data becomes unreliable with high possibility. Thus, by causing such input data to be selected as one of the pieces of learning data, the second evaluation unit 45 according to the third example can cause the first machine learning model to perform relearning with high accuracy.

In the third example, similarly to the second example, the candidate data transmission unit 43 of the edge device 21 may transmit the first evaluation data to the cloud device 22. In the third example, the second evaluation unit 45 may calculate the second evaluation value based on the first evaluation data received from the edge device 21 and the second evaluation data calculated by the cloud device 22. Due to this, the second evaluation unit 45 can reduce the arithmetic amount for calculating the second evaluation value.

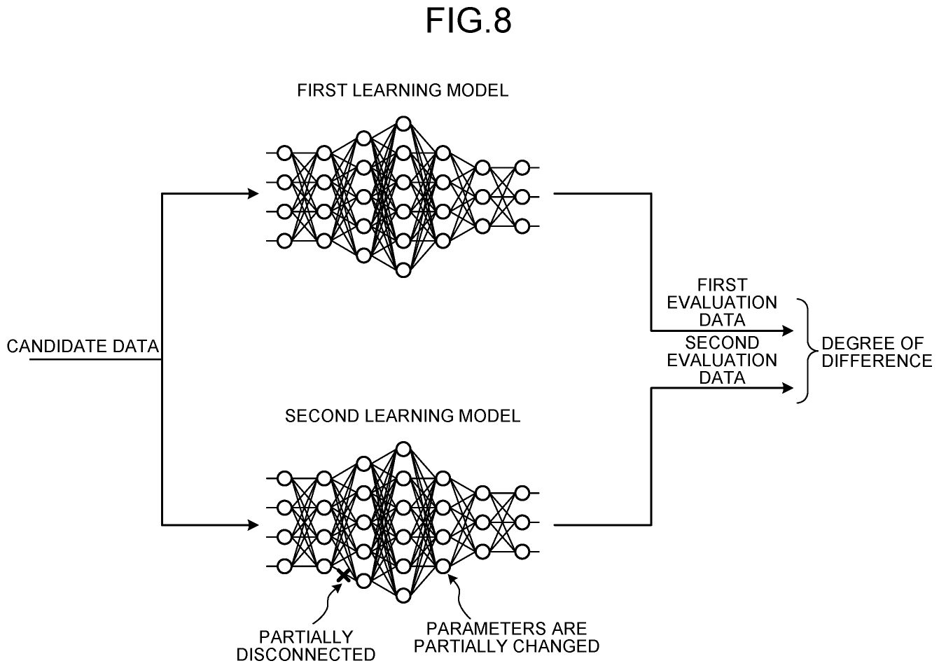

FIG. 8 is a diagram for explaining a fourth example of the calculation method for the second evaluation value performed by the second evaluation unit 45.

The second evaluation unit 45 according to the fourth example calculates, as the second evaluation value, a value according to a degree of difference representing a difference between the first evaluation data obtained by inputting the first candidate data to the first machine learning model and the second evaluation data obtained by inputting the first candidate data to a second machine learning model that is obtained by partially changing the first machine learning model.

More specifically, the first evaluation data according to the fourth example includes at least one of the output data of the first machine learning model and the intermediate data output from the predetermined position in the first machine learning model obtained by inputting the first candidate data to the first machine learning model. The second evaluation data according to the fourth example includes data corresponding to the first evaluation data, which is any of the output data of the second machine learning model and the intermediate data output from the predetermined position in the second machine learning model obtained by inputting the first candidate data to the second machine learning model that is obtained by partially changing the first machine learning model.

The second machine learning model is, for example, a model obtained by partially changing internal parameters of the first machine learning model. For example, in a case in which the second machine learning model is a neural network, the second machine learning model is a model for which, by causing a weight parameter to be 0 in transition of transmitting an ignition signal from an optional first node to a next second node, a path for transmitting the ignition signal from the first node to the second node is disconnected. The second machine learning model may also be a model obtained by minutely changing part of weight parameters of the first machine learning model.

Similarly to the second example, the second selection unit 46 according to the fourth example compares the second evaluation value with the standard value determined in advance, and selects the first candidate data as one of the pieces of learning data.

In a case in which estimation results calculated by two arithmetic processing devices having minutely different configurations are different from each other as described above, it is assumed that the inference result obtained by the first machine learning model using the input data becomes unreliable with high possibility. Thus, by causing such input data to be selected as one of the pieces of learning data, the second evaluation unit 45 according to the fourth example can cause the first machine learning model to perform relearning with high accuracy.

In the fourth example, similarly to the second example, the candidate data transmission unit 43 of the edge device 21 may transmit the first evaluation data to the cloud device 22. In the fourth example, the second evaluation unit 45 may calculate the second evaluation value based on the first evaluation data received from the edge device 21 and the second evaluation data calculated by the cloud device 22. Due to this, the second evaluation unit 45 can reduce the arithmetic amount for calculating the second evaluation value.

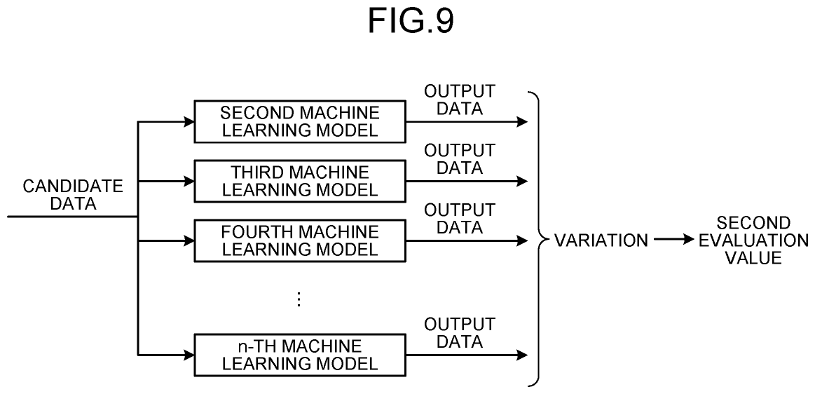

FIG. 9 is a diagram for explaining a fifth example of the calculation method for the second evaluation value performed by the second evaluation unit 45.

The second evaluation unit 45 according to the fifth example calculates, as the second evaluation value, a value representing variation among a plurality of pieces of output data. Herein, the pieces of output data are a plurality of inference results obtained by inputting the first candidate data to a plurality of machine learning models learned with learning parameters different from those of the first machine learning model. For example, the machine learning models include the second machine learning model, a third machine learning model, a fourth machine learning model, . . . , and an n-th machine learning model. In this case, each of the second to the n-th machine learning models performs learning with learning parameters different from those of the first machine learning model, and performs learning with learning parameters different from each other. Each of the second to the n-th machine learning models may be a neural network or another model.

Similarly to the second example, the second selection unit 46 according to the fifth example compares the second evaluation value with the standard value determined in advance, and selects the first candidate data as one of the pieces of learning data.

In a case in which estimation results calculated by using a plurality of different machine learning models are different from each other, it is assumed that the inference result obtained by the first machine learning model using the input data becomes unreliable with high possibility. Thus, by causing such input data to be selected as one of the pieces of learning data, the second evaluation unit 45 according to the fifth example can cause the first machine learning model to perform relearning with high accuracy.

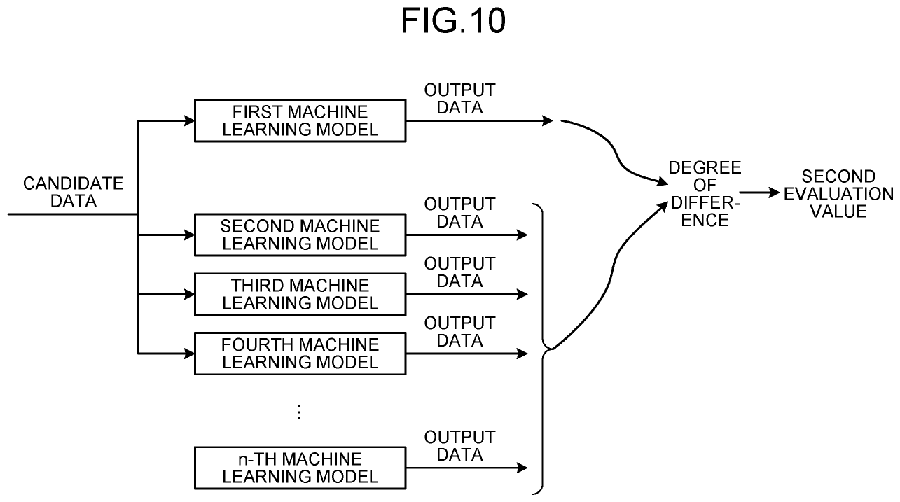

FIG. 10 is a diagram for explaining a sixth example of the calculation method for the second evaluation value performed by the second evaluation unit 45.

The second evaluation unit 45 according to the sixth example calculates, as the second evaluation value, a value based on a degree of difference representing a difference between first output data and each of one or more pieces of second output data. Herein, the first output data is the inference result obtained by inputting the first candidate data to the first machine learning model. The one or more pieces of second output data are respectively one or more inference results obtained by inputting the first candidate data to one or more machine learning models learned with learning parameters different from those of the first machine learning model. For example, the machine learning models include the second machine learning model, the third machine learning model, the fourth machine learning model, . . . , and the n-th machine learning model. In this case, each of the second to the n-th machine learning models performs learning with learning parameters different from those of the first machine learning model, and performs learning with learning parameters different from each other. Each of the one or more machine learning models may be a neural network or another model.

The second evaluation unit 45 may calculate the degree of difference based on an average value, a maximum value, or the like of a difference between the first output data and each of the one or more pieces of second output data. The second evaluation unit 45 may also calculate the degree of difference based on an average value, a maximum value, or the like of a difference between a value obtained by inputting the first output data to a predetermined function or a predetermined model and a value obtained by inputting each of the one or more pieces of second output data to the predetermined function or the predetermined model. Alternatively, for example, the second evaluation unit 45 may calculate a correlation value by inputting the first output data and each of the one or more pieces of second output data to a function or a model for calculating the correlation value representing strength of a correlation between the two pieces of data, and calculate the degree of difference based on the correlation value.

Similarly to the second example, the second selection unit 46 according to the sixth example compares the second evaluation value with the standard value determined in advance, and selects the first candidate data as one of the pieces of learning data.

In a case in which the estimation result calculated by using the first machine learning model is different from the estimation result calculated by using the second machine learning model as described above, it is assumed that the inference result obtained by the first machine learning model using the input data becomes unreliable with high possibility. Thus, by causing such input data to be selected as one of the pieces of learning data, the second evaluation unit 45 according to the sixth example can cause the first machine learning model to perform relearning with high accuracy.

The candidate data transmission unit 43 of the edge device 21 according to the sixth example acquires the first output data from the inference unit 32, and transmits the first output data to the cloud device 22 via the network. The second evaluation unit 45 acquires the first output data received from the edge device 21. The second evaluation unit 45 calculates each of the one or more pieces of second output data. The second evaluation unit 45 then calculates the second evaluation value based on the first output data received from the edge device 21 and the calculated one or more pieces of second output data. Due to this, the second evaluation unit 45 is not required to execute arithmetic processing for calculating the first output data, so that the arithmetic amount for calculating the second evaluation value can be reduced.

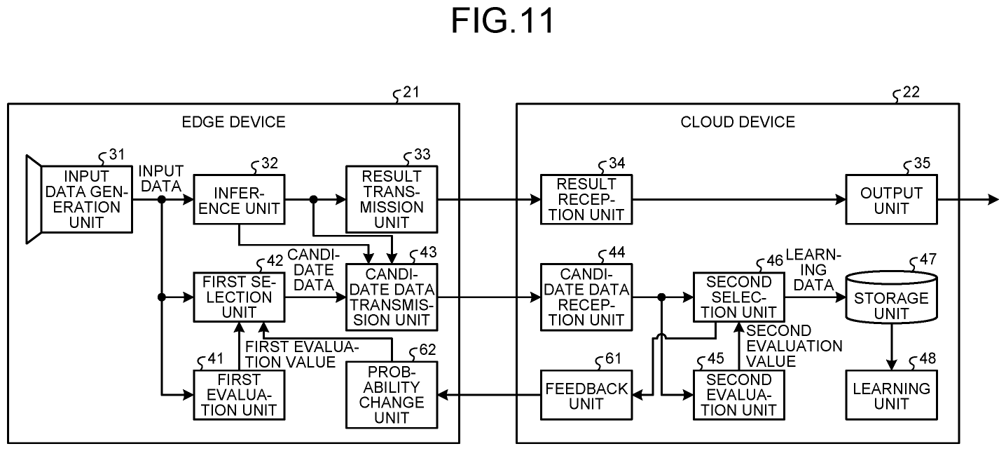

FIG. 11 is a block diagram illustrating a functional configuration of the edge device 21 and the cloud device 22 according to a modification.

The edge device 21 and the cloud device 22 may also have a configuration as illustrated in FIG. 11. That is, the cloud device 22 further includes a feedback unit 61. The edge device 21 further includes a probability change unit 62.

The edge device 21 generates a plurality of pieces of input data arranged on a time-series basis, and determines whether to select the generated input data as the candidate data each time of generating the input data. In a case of selecting the generated input data as the candidate data, the edge device 21 transmits the candidate data to the cloud device 22 via the network.

The cloud device 22 determines whether to select the received candidate data as the learning data each time of receiving the candidate data from the edge device 21, and in a case of selecting the received candidate data as the learning data, the cloud device 22 causes the storage unit 47 to store the selected candidate data as the learning data.

Herein, in the modification, each time the learning data is selected by the second selection unit 46, the feedback unit 61 transmits, to the edge device 21, employment information indicating that the input data corresponding to the selected learning data is selected as the learning data via the network.

The probability change unit 62 receives the employment information from the cloud device 22 via the network. In a case of receiving the employment information, the probability change unit 62 causes a probability of selecting, as the candidate data, the input data acquired in a time range determined in advance after the input data indicated by the employment information to be higher than a probability of selecting another time range.

The pieces of time-series input data have the property that two or more pieces of data that are temporally close to each other have a high correlation and are similar to each other with high possibility. Due to this, regarding the other piece of input data temporally close to the input data the inference result of which obtained by the first machine learning model becomes unreliable with high possibility, it is similarly estimated that the inference result thereof becomes unreliable with high possibility. Thus, by increasing the probability of selecting, as the candidate data, the input data close to the input data the inference result of which becomes unreliable with high possibility, the probability change unit 62 can cause more input data that may be employed as the learning data with high possibility to be transmitted to the cloud device 22. Due to this, the probability change unit 62 can cause the first machine learning model to perform relearning with high accuracy.

As described above, by calculating the first evaluation value by the edge device 21 and transmitting the candidate data as a candidate for the learning data from among the pieces of input data, the machine learning system 10 according to the present embodiment can reduce possibility of transmitting, to the cloud device 22, the pieces of candidate data that are not effective for learning and similar to each other. Accordingly, the edge device 21 can select the pieces of candidate data effective for learning from among the pieces of input data through relatively simple processing, and can reduce a transmission amount of data to the cloud device 22.

Furthermore, the machine learning system 10 according to the present embodiment calculates the second evaluation value by the cloud device 22 having high arithmetic capacity, and selects the learning data from among the pieces of candidate data, so that it is possible to select, with high accuracy, the input data the inference result of which becomes unreliable with high possibility. Thus, with the machine learning system 10 according to the present embodiment as described above, the input data effective for learning can be selected from among the pieces of input data with high accuracy and high efficiency.

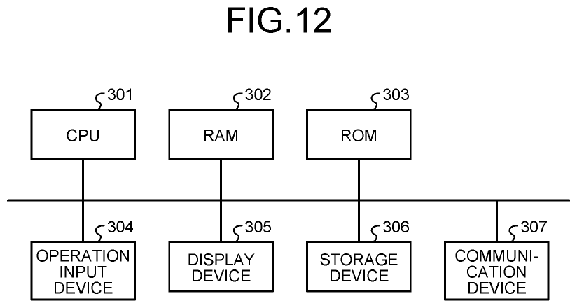

FIG. 12 is a diagram illustrating an example of a hardware configuration of an information processing device constituting the edge device 21 and the cloud device 22. The information processing device constituting the edge device 21 and the cloud device 22 is implemented by a hardware configuration similar to a computer illustrated in FIG. 12, for example. The information processing device constituting the cloud device 22 may have a configuration not including an operation input device 304 and a display device 305.

The information processing device includes a CPU 301, a random access memory (RAN) 302, a read only memory (ROM) 303, the operation input device 304, the display device 305, a storage device 306, and a communication device 307. These components are connected to each other via a bus.

The CPU 301 is a processor that executes arithmetic processing, control processing, and the like in accordance with a computer program. The CPU 301 executes various kinds of processing in cooperation with computer programs stored in the ROM 303, the storage device 306, and the like using a predetermined region of the RAM 302 as a working area.

The RAM 302 is a memory such as a Synchronous Dynamic Random Access Memory (SDRAM). The RAM 302 functions as the working area of the CPU 301. The ROM 303 is a memory that stores computer programs and various kinds of information in a non-rewritable manner.

The operation input device 304 is an input device such as a mouse, a keyboard, and the like. The operation input device 304 receives information operationally input by the user as an instruction signal, and outputs the instruction signal to the CPU 301.

The display device 305 is a display device such as a Liquid Crystal Display (LCD). The display device 305 displays various kinds of information based on a display signal from the CPU 301.

The storage device 306 is a device that writes and reads out data into/from a storage medium constituted of a semiconductor such as a flash memory, a storage medium in which data can be magnetically or optically recorded, or the like. The storage device 306 writes and reads out data into/from the storage medium in accordance with control by the CPU 301. The communication device 307 communicates with an external device via the network in accordance with control by the CPU 301.

A computer program executed by the information processing device implementing the edge device 21 has a module configuration including an input data generation module, an inference module, a result transmission module, a first evaluation module, a first selection module, and a candidate data transmission module. When being loaded into the RAM 302 to be executed by the CPU 301 (processor), this computer program causes the information processing device to function as the input data generation unit 31, the inference unit 32, the result transmission unit 33, the first evaluation unit 41, the first selection unit 42, and the candidate data transmission unit 43. In the information processing device, part or all of the input data generation unit 31, the inference unit 32, the result transmission unit 33, the first evaluation unit 41, the first selection unit 42, and the candidate data transmission unit 43 may be implemented by a hardware circuit.

A computer program executed by the information processing device implementing the cloud device 22 has a module configuration including a result reception module, an output module, a candidate data reception module, a second evaluation module, a second selection module, and a learning module. When being loaded into the RAM 302 to be executed by the CPU 301 (processor), this computer program causes the information processing device to function as the result reception unit 34, the output unit 35, the candidate data reception unit 44, the second evaluation unit 45, the second selection unit 46, and the learning unit 48. In the information processing device, part or all of the result reception unit 34, the output unit 35, the candidate data reception unit 44, the second evaluation unit 45, the second selection unit 46, and the learning unit 48 may be implemented by a hardware circuit.

The computer program executed by a computer is recorded and provided in a computer-readable recording medium such as a CD-ROM, a flexible disk, a CD-R, and a digital versatile disc (DVD), as an installable or executable file.

This computer program may be stored in a computer connected to a network such as the Internet and provided by being downloaded via the network. This computer program may be provided or distributed via a network such as the Internet. The computer program executed by the information processing device may be embedded and provided in the ROM 303 and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Additional Note

The embodiment described above can be summarized as the following technical ideas.

Technical Idea 1

A machine learning system configured to select a plurality of pieces of learning data for causing a first machine learning model to perform learning from among a plurality of pieces of input data, the machine learning system including:
a first information processing device; and
a second information processing device connected to the first information processing device via a network, wherein
the first information processing device includes:
   a first evaluation unit configured to calculate a first evaluation value representing effectiveness of each of the pieces of input data when being used for learning of the first machine learning model based on a first evaluation standard determined in advance;
   a first selection unit configured to select whether each of the pieces of input data is to be included in a plurality of pieces of candidate data by comparing the first evaluation value of each of the pieces of input data with a value determined in advance; and
   a candidate data transmission unit configured to transmit each of the pieces of candidate data to the second information processing device via the network, and
the second information processing device includes:
   a candidate data reception unit configured to receive each of the pieces of candidate data from the first information processing device via the network;
   a second evaluation unit configured to calculate a second evaluation value indicating effectiveness of each of the pieces of candidate data when being used for learning of the first machine learning model based on a second evaluation standard determined in advance, where the second evaluation standard is different from the first evaluation standard; and
   a second selection unit configured to select whether each of the pieces of candidate data is to be included in the pieces of learning data by comparing the second evaluation value of each of the pieces of candidate data with a value determined in advance.

Technical Idea 2

The machine learning system according to Technical idea 1, wherein the first evaluation unit calculates the first evaluation value for first input data among the pieces of input data based on a relation between the first input data and data different from the first input data.

Technical Idea 3

The machine learning system according to Technical idea 2, wherein
the first evaluation unit calculates, as the first evaluation value, a value according to a time difference between acquisition time of the first input data and acquisition time of second input data that is selected as one of the pieces of candidate data immediately before the first input data among one or more pieces of the second input data different from the first input data, and
the first selection unit compares the first evaluation value with a standard value determined in advance, and selects the first input data as one of the pieces of candidate data.

Technical Idea 4

The machine learning system according to Technical idea 2, wherein
the first evaluation unit calculates, as the first evaluation value, a value according to a degree of difference representing a difference between the first input data and k (k is an integral number equal to or larger than 1) pieces of the candidate data immediately before the first input data among the pieces of candidate data, and
the first selection unit compares the first evaluation value with a standard value determined in advance, and selects the first input data as one of the pieces of candidate data.

Technical Idea 5

The machine learning system according to Technical idea 2, wherein
the first evaluation unit calculates, as the first evaluation value, a value according to a degree of difference representing a difference between the first input data and one or more pieces of data used for training of the first machine learning model, and
the first selection unit compares the first evaluation value with a standard value determined in advance, and selects the first input data as one of the pieces of candidate data.

Technical Idea 6

The machine learning system according to any one of Technical ideas 2 to 5, wherein
the first evaluation value represents a binary value of “effectiveness” or “ineffectiveness”,
the first evaluation unit calculates the first evaluation value based on a random number such that the “effectiveness” or the “ineffectiveness” occurs with a probability set in advance, and
the first selection unit selects the first input data as one of the pieces of candidate data in a case in which the first evaluation value indicates “selection”.

Technical Idea 7

The machine learning system according to any one of Technical ideas 1 to 6, wherein the second evaluation unit calculates the second evaluation value for first candidate data among the pieces of candidate data by analyzing an inference result or an intermediate result obtained by inputting the first candidate data to a machine learning model.

Technical Idea 8

The machine learning system according to Technical idea 7, wherein
the first machine learning model classifies input data into any of a plurality of classes,
the second evaluation unit acquires a classification probability of belonging to each of the classes obtained by inputting the first candidate data to the first machine learning model, and calculates, as the second evaluation value, a value according to a degree of difference representing a difference between a classification probability of a class into which the first candidate data is classified as belonging among the classes and a classification probability of each of one or a plurality of the classes into which the first candidate data is classified as not belonging, and
the second selection unit compares the second evaluation value with a standard value determined in advance, and selects the first candidate data as one of the pieces of learning data.

Technical Idea 9

The machine learning system according to Technical idea 7, wherein
the second evaluation unit calculates, as the second evaluation value, a value according to a degree of difference representing a difference between first evaluation data calculated by a first arithmetic processing device as hardware having first arithmetic accuracy and second evaluation data calculated by a second arithmetic processing device as hardware having second arithmetic accuracy higher than the first arithmetic accuracy,
the second selection unit compares the second evaluation value with a standard value determined in advance, and selects the first candidate data as one of the pieces of learning data,
the first evaluation data includes at least one of output data of the first machine learning model and intermediate data output from a predetermined position in the first machine learning model obtained by inputting the first candidate data to the first machine learning model, and
the second evaluation data includes data corresponding to the first evaluation data, which is any of the output data of the first machine learning model and the intermediate data output from the predetermined position in the first machine learning model obtained by inputting the first candidate data to the first machine learning model.

Technical Idea 10

The machine learning system according to Technical idea 7, wherein
the second evaluation unit calculates, as the second evaluation value, a value according to a degree of difference representing a difference between the first evaluation data obtained by inputting the first candidate data to the first machine learning model and second evaluation data obtained by inputting data that is obtained by partially changing the first candidate data to the first machine learning model,
the second selection unit compares the second evaluation value with a standard value determined in advance, and selects the first candidate data as one of the pieces of learning data,
the first evaluation data includes at least one of output data of the first machine learning model and intermediate data output from a predetermined position in the first machine learning model, and
the second evaluation data includes data corresponding to the first evaluation data, which is any of the output data of the first machine learning model and the intermediate data output from the predetermined position in the first machine learning model.

Technical Idea 11

The machine learning system according to Technical idea 7, wherein
the second evaluation unit calculates, as the second evaluation value, a value according to a degree of difference representing a difference between first evaluation data obtained by inputting the first candidate data to the first machine learning model and second evaluation data obtained by inputting the first candidate data to a second machine learning model that is obtained by partially changing the first machine learning model,
the second selection unit compares the second evaluation value with a standard value determined in advance, and selects the first candidate data as one of the pieces of learning data,
the first evaluation data includes at least one of output data of the first machine learning model and intermediate data output from a predetermined position in the first machine learning model, and
the second evaluation data includes data corresponding to the first evaluation data, which is any of the output data of the second machine learning model and the intermediate data output from the predetermined position in the second machine learning model.

Technical Idea 12

The machine learning system according to Technical idea 7, wherein
the second evaluation unit calculates, as the second evaluation value, a value representing variation among a plurality of pieces of output data,
the second selection unit compares the second evaluation value with a standard value determined in advance, and selects the first candidate data as one of the pieces of learning data, and
the pieces of output data are a plurality of inference results obtained by inputting the first candidate data to a plurality of machine learning models learned with learning parameters different from learning parameters of the first machine learning model.

Technical Idea 13

The machine learning system according to Technical idea 7, wherein
the second evaluation unit calculates, as the second evaluation value, a value based on a degree of difference representing a difference between first output data and each of one or more pieces of second output data,
the second selection unit compares the second evaluation value with a standard value determined in advance, and selects the first candidate data as one of the pieces of learning data,
the first output data is an inference result obtained by inputting the first candidate data to the first machine learning model, and
the one or more pieces of second output data are respectively one or more inference results obtained by inputting the first candidate data to one or more machine learning models learned with learning parameters different from learning parameters of the first machine learning model.

Technical Idea 14

The machine learning system according to any one of Technical ideas 1 to 13, wherein
the second information processing device further includes a feedback unit configured to transmit employment information indicating that the corresponding input data is selected as the learning data to the first information processing device each time the learning data is selected, and
the first information processing device receives the employment information, and causes a probability of selecting, as the candidate data, the input data acquired in a time range determined in advance after the input data indicated by the employment information to be higher than a probability of selecting another time range.

Technical Idea 15

The machine learning system according to any one of Technical ideas 1 to 14, wherein
the first information processing device further includes:
   an input data generation unit configured to collect observation results obtained by observing surroundings, and generate the pieces of time-series input data; and
   an inference unit configured to perform inference processing on the respective pieces of input data on a time-series basis based on the first machine learning model, and output an inference result obtained by performing the inference processing on a time-series basis,
the first selection unit determines whether to select each of the pieces of input data as a candidate based on the corresponding first evaluation value on a time-series basis, and
the second selection unit determines whether each of the pieces of candidate data is to be included in the pieces of learning data based on the corresponding second evaluation value on a time-series basis.

Technical Idea 16

The machine learning system according to any one of Technical ideas 1 to 15, wherein
the second information processing device further includes:
   a storage unit configured to store the pieces of learning data; and
   a learning unit configured to train the first machine learning model using the pieces of learning data stored in the storage unit.

Technical Idea 17

A machine learning system including:
a first information processing device including a first arithmetic processing device as hardware; and
a second information processing device that is hardware different from the first arithmetic processing device, and includes a second arithmetic processing device configured to execute information processing with higher arithmetic accuracy than the first arithmetic processing device, wherein
the first information processing device generates, using the first arithmetic processing device, first evaluation data including at least one of output data of a first machine learning model and intermediate data output from a predetermined position in the first machine learning model obtained by inputting each of a plurality of pieces of input data to the first machine learning model,
the second information processing device generates, using the second arithmetic processing device, second evaluation data including at least one of the output data of the first machine learning model and the intermediate data output from the predetermined position in the first machine learning model obtained by inputting each of the pieces of input data to the first machine learning model, and
the second information processing device selects, as learning data for training the first machine learning model, input data for which a difference between the first evaluation data and the second evaluation data is larger than a standard value determined in advance among the pieces of input data.

Technical Idea 18

An edge device in a machine learning system that includes the edge device and an information processing device connected to the edge device via a network, and selects a plurality of pieces of learning data for causing a first machine learning model to perform learning from among a plurality of pieces of input data, the edge device including:
a first evaluation unit configured to calculate a first evaluation value representing effectiveness of each of the pieces of input data when being used for learning of the first machine learning model based on a first evaluation standard determined in advance;
a first selection unit configured to select whether each of the pieces of input data is to be included in a plurality of pieces of candidate data by comparing the first evaluation value of each of the pieces of input data with a value determined in advance; and
a candidate data transmission unit configured to transmit each of the pieces of candidate data to the information processing device via the network, wherein
the information processing device includes:
   a candidate data reception unit configured to receive each of the pieces of candidate data from the edge device via the network;
   a second evaluation unit configured to calculate a second evaluation value indicating effectiveness of each of the pieces of candidate data when being used for learning of the first machine learning model based on a second evaluation standard determined in advance, where the second evaluation standard is different from the first evaluation standard; and
   a second selection unit configured to select whether each of the pieces of candidate data is to be included in the pieces of learning data by comparing the second evaluation value of each of the pieces of candidate data with a value determined in advance.

Technical Idea 19

An information processing device in a machine learning system that includes an edge device and the information processing device connected to the edge device via a network, and selects a plurality of pieces of learning data for causing a first machine learning model to perform learning from among a plurality of pieces of input data, wherein
the edge device includes:
   a first evaluation unit configured to calculate a first evaluation value representing effectiveness of each of the pieces of input data when being used for learning of the first machine learning model based on a first evaluation standard determined in advance;
   a first selection unit configured to select whether each of the pieces of input data is to be included in a plurality of pieces of candidate data by comparing the first evaluation value of each of the pieces of input data with a value determined in advance; and
   a candidate data transmission unit configured to transmit each of the pieces of candidate data to the information processing device via the network, and
the information processing device includes:
   a candidate data reception unit configured to receive each of the pieces of candidate data from the edge device via the network;
   a second evaluation unit configured to calculate a second evaluation value indicating effectiveness of each of the pieces of candidate data when being used for learning of the first machine learning model based on a second evaluation standard determined in advance, where the second evaluation standard is different from the first evaluation standard; and
   a second selection unit configured to select whether each of the pieces of candidate data is to be included in the pieces of learning data by comparing the second evaluation value of each of the pieces of candidate data with a value determined in advance.

What is claimed is:

1. A machine learning system configured to select a plurality of pieces of learning data for causing a first machine learning model to perform learning from among a plurality of pieces of input data, the machine learning system comprising:
a first information processing device; and
a second information processing device connected to the first information processing device via a network, wherein
the first information processing device comprises:
a first evaluation unit configured to calculate a first evaluation value representing effectiveness of each of the pieces of input data when being used for learning of the first machine learning model based on a first evaluation standard determined in advance;
a first selection unit configured to select whether each of the pieces of input data is included in a plurality of pieces of candidate data by comparing the first evaluation value of each of the pieces of input data with a value determined in advance; and
a candidate data transmission unit configured to transmit each of the pieces of candidate data to the second information processing device via the network, and
the second information processing device comprises:
a candidate data reception unit configured to receive each of the pieces of candidate data from the first information processing device via the network;
a second evaluation unit configured to calculate a second evaluation value indicating effectiveness of each of the pieces of candidate data when being used for learning of the first machine learning model based on a second evaluation standard determined in advance, the second evaluation standard being different from the first evaluation standard; and
a second selection unit configured to select whether each of the pieces of candidate data is included in the pieces of learning data by comparing the second evaluation value of each of the pieces of candidate data with a value determined in advance.

2. The machine learning system according to claim 1, wherein the first evaluation unit calculates the first evaluation value for first input data among the pieces of input data based on a relation between the first input data and data different from the first input data.

3. The machine learning system according to claim 2, wherein
the first evaluation unit calculates, as the first evaluation value, a value according to a time difference between acquisition time of the first input data and acquisition time of second input data that is selected as one of the pieces of candidate data immediately before the first input data among one or more pieces of the second input data different from the first input data, and
the first selection unit compares the first evaluation value with a standard value determined in advance, and selects the first input data as one of the pieces of candidate data.

4. The machine learning system according to claim 2, wherein
the first evaluation unit calculates, as the first evaluation value, a value according to a degree of difference representing a difference between the first input data and k pieces of the candidate data immediately before the first input data among the pieces of candidate data, k being an integral number equal to or larger than 1, and
the first selection unit compares the first evaluation value with a standard value determined in advance, and selects the first input data as one of the pieces of candidate data.

5. The machine learning system according to claim 2, wherein
the first evaluation unit calculates, as the first evaluation value, a value according to a degree of difference representing a difference between the first input data and one or more pieces of data used for training of the first machine learning model, and
the first selection unit compares the first evaluation value with a standard value determined in advance, and selects the first input data as one of the pieces of candidate data.

6. The machine learning system according to claim 2, wherein
the first evaluation value represents a binary value of effectiveness or ineffectiveness,
the first evaluation unit calculates the first evaluation value based on a random number such that the effectiveness or the ineffectiveness occurs with a probability set in advance, and
the first selection unit selects the first input data as one of the pieces of candidate data in a case in which the first evaluation value indicates selection.

7. The machine learning system according to claim 1, wherein the second evaluation unit calculates the second evaluation value for first candidate data among the pieces of candidate data by analyzing an inference result or an intermediate result obtained by inputting the first candidate data to a machine learning model.

8. The machine learning system according to claim 7, wherein
the first machine learning model classifies input data into any of a plurality of classes,
the second evaluation unit acquires a classification probability of belonging to each of the classes obtained by inputting the first candidate data to the first machine learning model, and calculates, as the second evaluation value, a value according to a degree of difference representing a difference between a classification probability of a class into which the first candidate data is classified as belonging among the classes and a classification probability of each of one or a plurality of the classes into which the first candidate data is classified as not belonging, and
the second selection unit compares the second evaluation value with a standard value determined in advance, and selects the first candidate data as one of the pieces of learning data.

9. The machine learning system according to claim 7, wherein
the second evaluation unit calculates, as the second evaluation value, a value according to a degree of difference representing a difference between first evaluation data calculated by a first arithmetic processing device as hardware having first arithmetic accuracy and second evaluation data calculated by a second arithmetic processing device as hardware having second arithmetic accuracy higher than the first arithmetic accuracy,
the second selection unit compares the second evaluation value with a standard value determined in advance, and selects the first candidate data as one of the pieces of learning data,
the first evaluation data includes at least one of output data of the first machine learning model and intermediate data output from a predetermined position in the first machine learning model obtained by inputting the first candidate data to the first machine learning model, and
the second evaluation data includes data corresponding to the first evaluation data, which is any of the output data of the first machine learning model and the intermediate data output from the predetermined position in the first machine learning model obtained by inputting the first candidate data to the first machine learning model.

10. The machine learning system according to claim 7, wherein
the second evaluation unit calculates, as the second evaluation value, a value according to a degree of difference representing a difference between first evaluation data obtained by inputting the first candidate data to the first machine learning model and second evaluation data obtained by inputting data that is obtained by partially changing the first candidate data to the first machine learning model,
the second selection unit compares the second evaluation value with a standard value determined in advance, and selects the first candidate data as one of the pieces of learning data,
the first evaluation data includes at least one of output data of the first machine learning model and intermediate data output from a predetermined position in the first machine learning model, and
the second evaluation data includes data corresponding to the first evaluation data, which is any of the output data of the first machine learning model and the intermediate data output from the predetermined position in the first machine learning model.

11. The machine learning system according to claim 7, wherein
the second evaluation unit calculates, as the second evaluation value, a value according to a degree of difference representing a difference between the first evaluation data obtained by inputting the first candidate data to the first machine learning model and second evaluation data obtained by inputting the first candidate data to a second machine learning model that is obtained by partially changing the first machine learning model,
the second selection unit compares the second evaluation value with a standard value determined in advance, and selects the first candidate data as one of the pieces of learning data,
the first evaluation data includes at least one of output data of the first machine learning model and intermediate data output from a predetermined position in the first machine learning model, and
the second evaluation data includes data corresponding to the first evaluation data, which is any of the output data of the second machine learning model and the intermediate data output from the predetermined position in the second machine learning model.

12. The machine learning system according to claim 7, wherein
the second evaluation unit calculates, as the second evaluation value, a value representing variation among a plurality of pieces of output data,
the second selection unit compares the second evaluation value with a standard value determined in advance, and selects the first candidate data as one of the pieces of learning data, and
the pieces of output data are a plurality of inference results obtained by inputting the first candidate data to a plurality of machine learning models learned with learning parameters different from learning parameters of the first machine learning model.

13. The machine learning system according to claim 7, wherein
the second evaluation unit calculates, as the second evaluation value, a value based on a degree of difference representing a difference between first output data and each of one or more pieces of second output data,
the second selection unit compares the second evaluation value with a standard value determined in advance, and selects the first candidate data as one of the pieces of learning data,
the first output data is an inference result obtained by inputting the first candidate data to the first machine learning model, and
the one or more pieces of second output data are respectively one or more inference results obtained by inputting the first candidate data to one or more machine learning models learned with learning parameters different from learning parameters of the first machine learning model.

14. The machine learning system according to claim 1, wherein
the second information processing device further comprises a feedback unit configured to transmit employment information indicating that corresponding input data is selected as the learning data, to the first information processing device each time the learning data is selected, and
the first information processing device receives the employment information, and makes a probability of selecting, as the candidate data, the input data acquired in a time range determined in advance after the input data indicated by the employment information to be higher than a probability of selecting another time range.

15. The machine learning system according to claim 1, wherein
the first information processing device further comprises:
an input data generation unit configured to collect observation results obtained by observing surroundings, and generate pieces of time-series input data; and
an inference unit configured to perform inference processing on the respective pieces of input data on a time-series basis based on the first machine learning model, and output an inference result obtained by performing the inference processing on a time-series basis,
the first selection unit determines whether to select each of the pieces of input data as a candidate based on a corresponding first evaluation value on a time-series basis, and
the second selection unit determines whether each of the pieces of candidate data is included in the pieces of learning data based on a corresponding second evaluation value on a time-series basis.

16. A machine learning system comprising:
a first information processing device including a first arithmetic processing device as hardware; and
a second information processing device that is hardware different from the first arithmetic processing device, and includes a second arithmetic processing device configured to execute information processing with higher arithmetic accuracy than the first arithmetic processing device, wherein
the first information processing device generates, using the first arithmetic processing device, first evaluation data including at least one of output data of a first machine learning model and intermediate data output from a predetermined position in the first machine learning model obtained by inputting each of a plurality of pieces of input data to the first machine learning model,
the second information processing device generates, using the second arithmetic processing device, second evaluation data including at least one of the output data of the first machine learning model and the intermediate data output from the predetermined position in the first machine learning model obtained by inputting each of the pieces of input data to the first machine learning model, and
the second information processing device selects, as learning data for training the first machine learning model, input data for which a difference between the first evaluation data and the second evaluation data is larger than a standard value determined in advance among the pieces of input data.

17. An edge device in a machine learning system that comprises the edge device and an information processing device connected to the edge device via a network, and selects a plurality of pieces of learning data for causing a first machine learning model to perform learning from among a plurality of pieces of input data, the edge device comprising:
a first evaluation unit configured to calculate a first evaluation value representing effectiveness of each of the pieces of input data when being used for learning of the first machine learning model based on a first evaluation standard determined in advance;
a first selection unit configured to select whether each of the pieces of input data is included in a plurality of pieces of candidate data by comparing the first evaluation value of each of the pieces of input data with a value determined in advance; and
a candidate data transmission unit configured to transmit each of the pieces of candidate data to the information processing device via the network, wherein
the information processing device comprises:
a candidate data reception unit configured to receive each of the pieces of candidate data from the edge device via the network;
a second evaluation unit configured to calculate a second evaluation value indicating effectiveness of each of the pieces of candidate data when being used for learning of the first machine learning model based on a second evaluation standard determined in advance, the second evaluation standard being different from the first evaluation standard; and
a second selection unit configured to select whether each of the pieces of candidate data is included in the pieces of learning data by comparing the second evaluation value of each of the pieces of candidate data with a value determined in advance.

18. An information processing device in a machine learning system that comprises an edge device and the information processing device connected to the edge device via a network, and selects a plurality of pieces of learning data for causing a first machine learning model to perform learning from among a plurality of pieces of input data, wherein
the edge device comprises:
a first evaluation unit configured to calculate a first evaluation value representing effectiveness of each of the pieces of input data when being used for learning of the first machine learning model based on a first evaluation standard determined in advance;
a first selection unit configured to select whether each of the pieces of input data is included in a plurality of pieces of candidate data by comparing the first evaluation value of each of the pieces of input data with a value determined in advance; and
a candidate data transmission unit configured to transmit each of the pieces of candidate data to the information processing device via the network, and
the information processing device comprises:
a candidate data reception unit configured to receive each of the pieces of candidate data from the edge device via the network;
a second evaluation unit configured to calculate a second evaluation value indicating effectiveness of each of the pieces of candidate data when being used for learning of the first machine learning model based on a second evaluation standard determined in advance, the second evaluation standard being different from the first evaluation standard; and
a second selection unit configured to select whether each of the pieces of candidate data is included in the pieces of learning data by comparing the second evaluation value of each of the pieces of candidate data with a value determined in advance.
